(19) United States
(12) Patent Application Publication
(10) Pub. No.: US 2026/0125783 A1
(43) Pub. Date: May 7, 2026

(54) Metal powder for additive manufacturing

(71) Applicant: ArcelorMittal, Luxembourg (LU)

(72) Inventors: Manuel SÁNCHEZ PONCELA, Avilés, Asturias (ES); Rosalia REMENTERIA FERNANDEZ, Avilés, Asturias (ES); Laura DEL RIO FERNANDEZ, Gozon, Asturias (ES); Verónica SUAREZ FERNANDEZ, Avilés, Asturias (ES)

(21) Appl. No.: 19/117,505

(22) PCT Filed: Oct. 11, 2023
(86) PCT No.: PCT/IB2023/060221

§ 371 Date: Apr. 1, 2025

(30) Foreign Application Priority Data
Oct. 19, 2022 (WO) PCT/IB2022/060030

(51) Int. Cl. C22C 38/04; B22F 1/05; B22F 9/08; B22F 10/28; B33Y 10/00; B33Y 70/10; B33Y 80/00; C22C 38/00; C22C 38/02; C22C 38/06

(52) U.S. Cl. CPC C22C 38/04; B22F 1/05; B22F 9/082; B22F 10/28; B33Y 10/00; B33Y 70/10; B33Y 80/00; C22C 38/001; C22C 38/002; C22C 38/02; C22C 38/06; B22F 2009/0824; B22F 2301/35; B22F 2304/10; B22F 2998/10; B22F 2999/00

(57) ABSTRACT

A metal powder for additive manufacturing having a composition including the following elements, expressed in content by weight 15%≤Mn≤35%, 6%≤Al≤15%, 0.5%≤C≤1.8%, 1.6%≤Si≤3.5%, P≤0.013%, S≤0.015%, N≤0.100%, and optionally containing Ni≤8.5 wt. % and/or Cr≤2.5 wt. % and/or B≤0.1 wt. % and/or one or more elements chosen among Ta, Zr, Nb, V, Ti, Mo, and W in a cumulated amount of up to 2.0 wt. %, the balance being iron and unavoidable impurities resulting from the elaboration. It also deals with a process for manufacturing such powder and for manufacturing a printed part out of it.

The present invention relates to a metal powder for the manufacturing of steel parts and in particular for their additive manufacturing. The present invention also relates to the method for manufacturing the metal powder.

### BACKGROUND

Environmental restrictions are forcing automakers to continuously reduce the CO2 emissions of their vehicles. To do that, automakers are looking at every way to reduce the weight of motor vehicles.

### SUMMARY OF THE INVENTION

This can in particular be achieved by reducing the density of the steels used for manufacturing parts, by alloying them with other, lighter metals than iron.

Steels containing high levels of manganese aluminum and carbon, often referred to as triplex steels, can show density levels below 7.4 g/cm3. Their solidified structure shows an austenitic structure possibly comprising kappa carbide (Fe,Mn)3AlCx and ferrite.

However, they are difficult to manufacture by conventional casting methods due to their high aluminum and carbon amounts. They also exhibit some macro-segregations of manganese, carbon and/or aluminum, generating bands when they are laminated and possibly forming brittle phases leading to cracks.

It is an object of the present invention to remedy the drawbacks of the prior art by providing a new way to obtain parts with low density without manufacturability issues.

The present invention provides a metal powder for additive manufacturing having a composition comprising the following elements, expressed in content by weight:

$$15 \% \leq Mn \leq 35 \%$$

$$6 \% \leq Al \leq 15 \%$$

$$0.5 \% \leq C \leq 1.8 \%$$

$$1.6 \% \leq Si \leq 3.5 \%$$

$$P \leq 0.013 \%$$

$$S \leq 0.015 \%$$

$$N \leq 0.1 \%$$

and optionally containing Ni≤8.5 wt. % and/or Cr≤2.5 wt. % and/or B≤0.1 wt. % and/or one or more elements chosen among Ta, Zr, Nb, V, Ti, Mo, and W in a cumulated amount of up to 2.0 wt. %, the balance being iron and unavoidable impurities resulting from the elaboration.

The metal powder according to the invention may also have the optional features listed below, considered individually or in combination:
the powder particles have an austenitic microstructure comprising up to 1 weight % of kappa carbides (Fe,Mn)₃AlCx and up to 20 weight % of ferrite and up to 1 weight % of AlN,
the powder has a density below 7.0 g/cm³,
the average particle size ranks from 1 to 150 μm,
the average particle size ranks from 1 to 20 μm,
the average particle size ranks from 20 to 63 μm,
the average particle size ranks from 60 to 150 μm.

The present invention also provides a process for manufacturing a metal powder for additive manufacturing, comprising:
a) Melting elements and/or metal-alloys at a temperature at least 100° C. above the liquidus temperature so as to obtain a molten composition as described above, and,
b) Atomizing the molten composition through a nozzle the diameter of which is at most 4 mm, with a gas pressurized from 10 to 30 bar.

The present invention also provides a process for manufacturing a printed part by additive manufacturing wherein a powder according to the invention is printed by Laser Powder Bed Fusion.

The printing process according to the invention may also have the optional features listed below, considered individually or in combination:
the process comprises a first step of forming a powder layer with a thickness below 100 μm and a second step where a focused laser beam forms a shaped layer by melting at least part of the powder layer in an atmosphere substantially composed of an inert gas,
the process is set with the following parameters:
   the laser power is limited to maximum 500 W,
   the scan speed is from 300 to 2000 mm/s,
   the Linear Energy Density is from 190 to 500 J/m,
   the hatch spacing is from 50 to 120 μm,
   The Volumetric Energy Density is from 100 to 330 J/mm3.

The present invention also provides a printed part obtained according to the invention having a cellular solidification structure with an equivalent diameter below 2 μm.

### DETAILED DESCRIPTION

The present invention will be better understood by reading the following description, which is provided purely for purposes of explanation and is in no way intended to be restrictive.

Manganese is present in the composition according to the invention at a content of 15 to 35 wt. %. Manganese is an essential alloying element for such grade, mainly due to the fact that alloying with very high amounts of manganese and carbon stabilizes, in the final part, the austenite down to room temperature, which can then tolerate high amounts of aluminum without being destabilized and transformed into too much ferrite or into martensite. To enable the alloy to have a superior ductility, the manganese content has to be equal or higher to 15 wt. %. However, when the manganese content is over 35 wt. %, the precipitation of β-Mn phase will deteriorate the ductility of the alloy. Therefore, the manganese content should be controlled to be equal or greater than 15 wt. %, but lower than equal to 35 wt. %. In a preferred embodiment, it is equal or greater than 15.5 wt. % or even than 16.0 wt. %. Its amount is more preferably from 25 to 31 wt. %, or even better from 26 to 30 wt. %.

Aluminum is present in the composition according to the invention at a content of 6 to 15 wt. %. Aluminum addition to high manganese austenitic steels effectively decreases the density of the alloy. In addition, it considerably increases the stacking fault energy (SFE) of the austenite in the final part, leading in turn to a change in the strain hardening behavior of the alloy. Aluminum is also one of the primary elements of nanosized kappa carbide (Fe,Mn)₃AlCx and therefore its addition significantly enhances the formation of such carbides. The aluminum concentration of the present alloys should be adjusted, on the one hand, to guarantee the austenite stability and the possible precipitation of kappa carbides, and on the other hand to control the formation of ferrite. Moreover, it has been observed that an aluminum amount below 6 wt. % leads to a density of the material higher than 7.0 g/cm³ in the final part. Therefore, the aluminum content should be controlled to be equal or greater than 6 wt. %, but lower than or equal to 15 wt. % to avoid removing the austenitic phase. In a preferred embodiment, the aluminum content is from 6 to 12 wt. %, or even better from 6 to 10 wt. %.

The carbon content is set at 0.5 to 1.8 wt. %. Carbon plays an important role in the formation of the microstructure of the final part. Its main role is to stabilize austenite which is the main phase of the microstructure of the steel part as well as to provide strengthening. Carbon content below 0.5 wt. % will decrease the proportion of austenite, which leads to the decrease of both ductility and strength of the alloy. However, since it is a main constituent element of the kappa carbide (Fe,Mn)₃AlCx, a carbon content above 1.8 wt. % can promote the precipitation of such carbides in a coarse manner on the grain boundaries, which results in the decrease of the ductility of the alloy.

Preferably, the carbon content is from 0.6 to 1.3 wt. %, more preferably from 0.8 to 1.2% by weight so as to obtain sufficient strength.

Silicon is present in the composition according to the invention at a content from 1.6 to 3.5 wt. %. It has been observed that the addition of at least 1.6 wt. % of silicon was suppressing hot cracking that occurs when producing the final part by additive manufacturing. However, an addition above 3.5 wt. % leads to cold cracking failure when producing the final part by additive manufacturing. Preferred ranges are from 1.7 to 3.5 wt. %, 1.8 to 3.5 wt. %, 1.7 to 2.5 wt. % or even better from 1.8 to 2.2 wt. %.

Nickel may be optionally present in a content up to 8.5 wt. %. Nickel can be used as a diffusion barrier to hydrogen. A Nickel amount higher than 8.5 wt. % is not desired because it promotes the formation of cementite in detriment of the (Fe,Mn)₃AlCx carbides. Nickel can also be used as an effective alloying element because it stabilizes the austenite, and also promotes the formation of ordered compounds in ferrite, such as the B2 component, leading to additional strengthening. However, it is desirable, among others for cost reasons, to limit the nickel addition to a maximum content of 6.0 wt. % or less or 4 wt. % or less and preferably from 0.1 to 2.0 wt. % or from 0.1 to 1.0 wt. %. When nickel is not added, the composition may however comprise up to 0.1 wt. % of nickel as an impurity.

Chromium may be optionally present in a content up to 2.5 wt. % for increasing the strength of the steel by solution hardening. It also enhances the high temperature corrosion resistance of the steels according to the invention. However, since chromium reduces the stacking fault energy and the stability of austenite, its content must not exceed 2.5 wt. % and preferably from 0.1% to 2.0 wt. % or from 0.1 to 1.0 wt. %. When chromium is not added, the composition may however comprise up to 0.1 wt. % of Cr as an impurity.

Boron may be optionally present in a content up to 0.1 wt. %. Boron has a very low solid solubility and a strong tendency to segregate at the grain boundaries, interacting strongly with lattice imperfections. Therefore, boron can be used to limit the precipitation of intergranular kappa carbides.

Tantalum, zirconium, niobium, vanadium, titanium, molybdenum and tungsten are elements that may optionally be used to achieve hardening and strengthening, notably by precipitation of nitrides, carbo-nitrides or carbides. However, when their cumulated amount is above 2.0 wt. %, preferably above 1.0 wt. %, or even better above 0.5 or above 0.3 wt. %, there is a risk that an excessive precipitation may cause a reduction in toughness, which has to be avoided.

The balance is made of iron and unavoidable impurities resulting from the elaboration. Phosphorus, sulfur and nitrogen are the main impurities. They are not deliberately added. They might notably be present in the ferroalloys and/or pure elements used as raw materials. Nitrogen can also be introduced during atomization. Their content is preferably controlled to avoid changing detrimentally the microstructure and/or to avoid increasing the brittleness. Therefore, their content is respectively limited to 0.013 wt. %, to 0.015 wt. % and to 0.1 wt. %. In a preferred embodiment, their content is respectively limited to 0.005 wt. % to 0.015 wt. % and to 0.01 wt. %.

The microstructure of the powder is mainly austenitic and may optionally include up to 1 wt. % of kappa carbides (Fe,Mn)₃AlCx, up to 1 wt. % of AlN and up to 20 wt. % of ferrite. In a preferred embodiment, the optional ferrite content can be from 4 to 10 wt. %.

The powder can be obtained by first mixing and melting pure elements and/or ferroalloys as raw materials. It can also be obtained by using a pre-alloyed ingot of the required composition.

Ferroalloys refer to various alloys of iron with a high proportion of one or more other elements such as manganese silicon, aluminum, niobium, boron, chromium, molybdenum et cetera. The main alloys are FeMn (usually comprising 70 to 80 wt. % Mn), FeAl (usually comprising 40 to 60 wt. % Al), FeSi (usually comprising 15 to 90 wt. % Si), FeNi (usually comprising 70 to 95 wt. % Ni), FeB (usually comprising 17.5 to 20 wt. % B), FeCr (usually comprising 50 to 70 wt. % Cr), FeMo (usually comprising 60 to 75 wt. % Mo), FeNb (usually comprising 60 to 70 wt. % Nb), FeV (usually comprising 35 to 85 wt. % V), FeW (usually comprising 70 to 80 wt. % W).

Alloying elements can be alternatively added as pure elements (usually with a purity over 99 wt. %). Pure elements can notably be carbon and pure metals such as iron, aluminum, manganese or nickel, zirconium, titanium, tantalum, molybdenum, tungsten, niobium, vanadium, chromium.

The person skilled in the art knows how to mix different ferroalloys and pure elements to reach a targeted composition.

Once the composition has been obtained by the mixing of the pure elements and/or ferroalloys in appropriate proportions, the composition is heated at a temperature of at least 100° C. above its liquidus temperature and maintain at this temperature to melt all the raw materials and homogenize the melt. Thanks to this overheating, the decrease in viscosity of the melted composition helps obtaining a powder with a high sphericity without satellites and with a proper particle size distribution. That said, as the surface tension increases with temperature, it is preferred not to heat the composition at a temperature more than 450° C. above its liquidus temperature.

Preferably, the composition is heated at a temperature of at least 200° C. above its liquidus temperature to promote the formation of highly spherical particles. More preferably, the composition is heated at a temperature of 250° C. above its liquidus temperature.

In one embodiment of the invention, the composition is heated from 1650 to 1800° C. which represents a good compromise between viscosity decrease and surface tension increase.

The molten composition is then atomized into fine metal droplets by forcing a molten metal stream through an orifice, the nozzle, at moderate pressure and by impinging it with jets of gas (gas atomization). The gas is introduced into the metal stream just before it leaves the nozzle, serving to create turbulence as the entrained gas expands (due to heating) and exits into a large collection volume, the atomizing tower. The latter is filled with gas to promote further turbulence of the molten metal jet. The metal droplets cool down during their fall in the atomizing tower. Gas atomization is preferred because it favors the production of powder particles having a high degree of roundness and a low number of satellites.

The atomization gas is preferably argon or nitrogen or a mixture thereof. They both increase the melt viscosity slower than other gases, e.g., helium, which promotes the formation of smaller particle sizes. They also control the purity of chemistry and play a role in the good morphology of the powder. Finer particles can usually be obtained with argon than with nitrogen since the molar weight of nitrogen is 14.01 g/mole compared with 39.95 g/mole for argon. On the other hand, the specific heat capacity of nitrogen is 1.04 J/(g K) compared with 0.52 for argon. So, nitrogen increases the cooling rate of the particles. Whenever nitrogen is used as a component of the atomization process, up to 1 weight % of AlN can be formed through the combination of aluminum and nitrogen.

The gas pressure is of importance since it directly impacts the particle size distribution. In particular, the higher the pressure, the higher the cooling rate. Preferably, the gas pressure is set from 10 to 30 bar, or even better from 24 to 30 bar, to promote the formation of particles whose size is most compatible with the additive manufacturing techniques.

The nozzle diameter has an impact on the molten metal flow rate and, thus, on the particle size distribution and on the cooling rate. The nozzle diameter is preferably limited to 4 mm to limit the increase in mean particle size and the decrease in cooling rate.

The metal powder obtained by atomization can be either used as such or can be sieved to keep the particles whose size better fits the additive manufacturing technique to be used afterwards. For example, in case of additive manufacturing by Powder Bed Fusion, the range 20-63 μm (called fraction F2) is preferred and the range 20-40 μm is even better. In the case of additive manufacturing by Laser Metal Deposition or Direct Metal Deposition, the range 60-150 μm (called F3) is preferred and the range 40-125 μm is even better. Fraction F1 covering particles sizes below 20 μm or even 10 μm can be used for example in binder jetting.

The parts made of the metal powder according to the invention can be obtained by additive manufacturing techniques such as Powder Bed Fusion (LPBF), Direct metal laser sintering (DMLS), Electron beam melting (EBM), Selective heat sintering (SHS), Selective laser sintering (SLS), Laser Metal Deposition (LMD), Direct Metal Deposition (DMD), Direct Metal Laser Melting (DMLM), Direct Metal Printing (DMP), Laser Cladding (LC), Binder Jetting (BJ), Cold Spray (CS), Thermal Spray (TS), High Velocity Oxygen Fuel (HVOF).

In particular, the invention can make use of LPBF process which is a layer-upon-layer additive manufacturing technique. Thin layers of metal powder are evenly distributed using a coating mechanism onto a substrate platform, usually metal, that is fastened to an indexing table that moves in the vertical axis. This takes place inside a chamber containing a tightly controlled atmosphere. Once each layer has been distributed, each 2D slice of the part geometry is fused by selectively melting the powder. This is accomplished with a high-power laser beam, usually an ytterbium fiber laser. The laser energy is intense enough to permit full melting (welding) of the particles in the form of a track or strip. Basically, once a track is done, the process is repeated with the next track, which is separated from the first one by the hatch spacing. The process is repeated layer after layer until the part is complete. The overhanging geometry is supported by nonmelted powder from previous layers. The main process parameters used in LPBF are usually the layer thickness, the hatch spacing, the scan speed and the laser power. After completing the process, the left-over powder is screened to be reused.

The process for producing an additively manufactured part by LPBF comprises a first step of forming a powder layer with the powder according to the invention. Preferably the powder layer is less than 100 μm. Above 100 μm, the laser might not melt the powder in all the layer thickness, which might lead to porosity in the part. Preferably, the layer thickness is kept from 20 to 60 μm to optimize the melting of the powder.

In a second step, a focused laser beam forms a shaped layer by melting at least part of the powder layer in the process conditions detailed below.

In the case of LPBF, each layer of the printed part is at least partially melted in an atmosphere substantially composed of an inert gas.

The laser power is preferably limited to a maximum of 500 W. Preferably, the laser power is set above 80 W to ease the melting in all the layer thickness. In a preferred embodiment, the laser power is from 175 to 300 W.

The scan speed is preferably from 300 to 2000 mm/s and more preferably from 300 to 700 mm/s. Below 300 mm/s, the excess energy provided by the laser might lead key-hole porosity and/or to spatters which, if not properly drag outside of the powder bed, deposit on the powder layer which create voids in the printed part. Above 2000 mm/s, the energy provided by the laser to the powder might not be enough to melt the powder in all the layer thickness.

The Linear Energy Density (LED) is preferably from 190 to 500 J/m. LED is defined as the ratio between the laser power and the scan speed expressed in m/s. Below 190 J/m, LED might not be enough to properly print parts (due to keyholing). Above 400 J/m, the excess energy provided by the laser might lead to spatters which, if not properly drag outside of the powder bed, deposit on the powder layer. Such deposits create voids in the printed part.

The hatch spacing is preferably from 50 to 120 μm. Below 50 μm, each point of the printed part might be remelted multiple times which might lead to overheating. Above 120 μm, non-melted powder might be trapped between two tracks. More preferably, the hatch spacing is from 70 to 110 μm.

The Volumetric Energy Density (VED) is preferably from 100 to 330 J/mm³. VED is defined as P/(v·h·lₜ), where P is the laser power, v is the scan speed, h is the hatch spacing and lₜ is the powder layer thickness.

Depending on the additive manufacturing process used, the microstructure of the parts can be different but are in each case solidification microstructures. Such solidification microstructures are determined by the temperature gradient (G) and growth rate (R) as they involve high cooling rates typical of additive manufacturing methods [Kou, S. (2020). Welding metallurgy. John Wiley & Sons].

As detailed by Agarwal, G. (2019) and shown in FIG. 2.12 of “Study of Solidification Cracking during Laser Welding in Advanced High Strength Steels. A Combined Experimental and Numerical Approach. Delft University of Technology”, the values of G and R and of the cooling rate define different zones of existence of solidification structures that can be cellular, cellular-dendritric or columnar dendritic.

In the present invention, solidification cellular cells with an equivalent diameter below 2 μm were observed when using LPBF method.

### Examples

The following examples and tests presented hereunder are non-restricting in nature and must be considered for purposes of illustration only. They will illustrate the advantageous features of the present invention, the significance of the parameters chosen by inventors after extensive experiments and further establish the properties that can be achieved by the metal powder according to the invention.

Different metal compositions as described in table 1 were first obtained by mixing and melting ferroalloys and pure elements.

TABLE 1

| Powder | Mn (wt. %) | Al (wt. %) | C (wt. %) | Si (wt. %) | Fe |
|---|---|---|---|---|---|
| 1 | 28 | 7 | 0.8 | 1.0 | Balance |
| 2* | 28 | 7 | 0.8 | 2.0 | Balance |
| 3 | 28 | 7 | 0.8 | 4.0 | Balance |
| 4 | 28 | 5 | 0.8 | 1.6 | Balance |
| 5* | 30 | 7 | 0.8 | 1.6 | Balance |
| 6 | 30 | 7 | 0.8 | 1.4 | Balance |
| 7* | 28 | 10 | 0.8 | 1.6 | Balance |
| 8 | 28 | 10 | 0.8 | 1.0 | Balance |
| 9* | 26 | 7 | 0.8 | 1.6 | Balance |
| 10 | 26 | 7 | 0.8 | 1.4 | Balance |

*according to the invention

P, S and N were respectively maintained below 0.013 wt. %, 0.015 wt. % and 0.1 wt. %.

These metal compositions were heated up to 1800° C., i.e., 200-350° C. above the liquidus temperature, and were then gas atomized with nitrogen in the following process conditions:
Gas pressure: 20 bar, and
Nozzle diameter: 2.5 to 3 mm.

The powders are then sieved and classified into F1 to F3 fractions. Their flowability, sphericity and roundness were evaluated and found satisfying for additive manufacturing use. The density of the powders was around 6.9 g/cm³.

For powders 1, 2 and 3, the microstructure of the F2 fraction was determined by XRD and gathered in Table 2.

TABLE 2

| | | | | | Kappa |
|---|---|---|---|---|---|
| | Austenite | Ferrite | Ordered phases | AlN | carbides |
| Powder | (wt %) | (wt. %) | (wt. %) | (wt. %) | (wt. %) |
| 1 | 95.7 | 4.3 | — | <1 | <1 |
| 2* | 93.3 | 6.7 | — | <1 | <1 |
| 3 | 64.3 | 29.8 | 5.9 | <1 | <1 |

*according to the invention

The fraction F2 of such powders was then used to print series of 22 cubes of 1 cm³ by LPBF, using the following parameters:
Laser power from 150 to 200 W,
Scan speed from 300 to 1100 mm/s,
Hatch spacing from 70 to 110 μm,
Layer thickness from 20 to 40 μm,
Linear Energy Density (LED) from 180 to 500 J/m, and
Volumetric Energy Density (VED) from 100 to 330 J/mm³.

The cubes were then evaluated, and the corresponding results are gathered in below table 3.

TABLE 3

| Powder | Cubes |
|---|---|
| 1 | Hot cracking |
| 2* | No cracks |
| 3 | Cold cracking |
| 4 | Hot cracking |
| 5* | No cracks |
| 6 | Hot cracking |
| 7* | No cracks |
| 8 | Hot cracking |
| 9* | No cracks |
| 10 | Hot cracking |

*according to the invention

The printed cubes of trials 1, 4, 6, 8 and 10 exhibited hot cracking. Such cracks were present all along the solidification front in all cubes.

The printed cubes of trial 3 exhibited major cracks due to internal stresses generating cold cracking. Such cracks are mainly due to the increase of hardness brought by silicon addition which goes together with a severe increase of brittleness.

The printed cubes of trials 2, 5, 7 and 9, which are according to the invention, led to cubes without internal cracks.

For powders 1, 2 and 3, the microstructure of the printed cubes was determined by XRD and gathered in Table 4.

TABLE 4

| | Austenite | Ferrite | Ordered | Kappa carbides |
|---|---|---|---|---|
| Powder | (wt. %) | (wt. %) | phases (wt. %) | (wt. %) |
| 1 | 99.1 | 0.9 | — | <1 |
| 2* | 94.5 | 5.5 | — | <1 |
| 3 | 31.2 | 30.7 | 38.1 | <1 |

*according to the invention

The microstructure of the printed cubes using powder 2 was assessed and shows cellular solidification cells with an equivalent diameter below 2 μm. Such cell sizes were determined by the line intercept method of ASTM E112-10 standard by using transverse SEM micrographs.

Sample 3 microstructure includes some ordered phases corresponding to (Fe,Mn)+ (N,C) and to (Fe,Mn) 3 (Si).

What is claimed is:

1-12. (canceled)

13. A metal powder for additive manufacturing having a composition comprising the following elements, expressed in content by weight:
$$15 \% \leq Mn \leq 35 \% ;$$
$$6 \% \leq Al \leq 15 \% ;$$
$$0.5 \% \leq C \leq 1.8 \% ;$$
$$1.6 \% \leq Si \leq 3.5 \% ;$$
$$P \leq 0.013 \% ;$$
$$S \leq 0.015 \% ;$$
$$N \leq 0.1 \% ;$$
and optionally containing at least one of the following:
Ni≤8.5 wt. %; Cr≤2.5 wt. %; B≤0.1 wt. % and one or more elements chosen from at least one of the group consisting of: Ta, Zr, Nb, V, Ti, Mo, and W in a cumulated amount of up to 2.0 wt. %; and
a balance being iron and unavoidable impurities resulting from the elaboration.

14. The metal powder according to claim 13 wherein the powder particles have an austenitic microstructure including optionally up to 1 weight % of kappa carbides (Fe,Mn)₃AlCx, up to 1 weight % of AlN, and up to 20 weight % of ferrite.

15. The metal powder according to claim 13 wherein the density of the metal powder is below 7.0 g/cm³.

16. The metal powder according to claim 13 wherein an average particle size ranks from 1 to 150 μm.

17. The metal powder according to claim 16 wherein the average particle size ranks from 1 to 20 μm.

18. The metal powder according to claim 16 wherein the average particle size ranks from 20 to 63 μm.

19. The metal powder according to claim 16 wherein the average particle size ranks from 60 to 150 μm.

20. A process for manufacturing a metal powder for additive manufacturing, comprising:
melting elements or metal-alloys at a temperature at least 100° C. above the liquidus temperature to obtain a molten composition, the molten composition being the composition as recited in claim 13; and
atomizing the molten composition through a nozzle with a gas pressurized from 10 to 30 bar.

21. A process for manufacturing a printed part by additive manufacturing wherein the metal powder as recited in claim 13 is printed by Laser Powder Bed Fusion.

22. The process according to claim 21 including:
a first step of forming a powder layer with a thickness below 100 μm; and
a second step where a focused laser beam forms a shaped layer by melting at least part of the powder layer in an atmosphere substantially composed of an inert gas.

23. The process according to claim 21 wherein:
a laser power is limited to maximum 500 W,
a scan speed is from 300 to 2000 mm/s,
a Linear Energy Density is from 190 to 500 J/m,
a the hatch spacing is from 50 to 120 μm, and
a Volumetric Energy Density is from 100 to 330 J/mm³.

24. A printed part obtained by the process according to claim 21, the printed part having a cellular solidification structure with an equivalent diameter below 2 μm.

25. A process for manufacturing a printed part by additive manufacturing wherein the metal powder obtained as recited in claim 20 is printed by Laser Powder Bed Fusion.

26. The process according to claim 25 including:
a first step of forming a powder layer with a thickness below 100 μm; and
a second step where a focused laser beam forms a shaped layer by melting at least part of the powder layer in an atmosphere substantially composed of an inert gas.

27. The process according to claim 25 wherein:
a laser power is limited to maximum 500 W,
a scan speed is from 300 to 2000 mm/s,
a Linear Energy Density is from 190 to 500 J/m,
a the hatch spacing is from 50 to 120 μm, and
a Volumetric Energy Density is from 100 to 330 J/mm³.

28. A printed part obtained by the process according to claim 25, the printed part having a cellular solidification structure with an equivalent diameter below 2 μm.
